(19) United States
(12) Patent Application Publication
(10) Pub. No.: US 2023/0164386 A1
(43) Pub. Date: May 25, 2023

(54) MICRO LED 8K VIDEO PROCESSING SYSTEM AND METHOD

(71) Applicant: KONKA GROUP CO., LTD., Shenzhen (CN)

(72) Inventors: RUI ZHU, SHENZHEN (CN); NING LIANG, SHENZHEN (CN)

(21) Appl. No.: 17/920,701

(22) PCT Filed: Dec. 2, 2020
(86) PCT No.: PCT/CN2020/133306

§ 371 Date: Oct. 21, 2022

(30) Foreign Application Priority Data
Jun. 30, 2020 (CN) 202010611848.3

(51) Int. Cl. H04N 21/4402; H04N 19/59; H04N 21/43; H04N 21/845

(52) U.S. Cl. CPC H04N 21/440263; H04N 19/59; H04N 21/43072; H04N 21/8456

(57) ABSTRACT

Disclosed are a Micro LED 8K video processing system and method therefor. The system comprises: a television signal source, used for outputting video sources having different resolutions; a video processing board, used for receiving the video sources output by the television signal source, identifying the resolutions of the video sources, stretching or compressing the video sources according to the resolution required to be output to obtain a video image, segmenting the video image into multiple video signals, synchronously sending the multiple video signals to 4K signal processing boards, and sending an audio decoding signal in the video sources to a loudspeaker; the 4K signal processing boards, used for decoding the received video signals into RGB pixel signals, and sending the RGB pixel signals to a Micro LED display screen; and the Micro LED display screen, used for lighting the entire screen according to the RGB pixel signals.

### CROSS-REFERENCES TO RELATED APPLICATIONS

This application claims priority to Chinese Patent Application No. 202010611848.3, titled “Micro LED 8K video processing system and method therefor”, and filed on Jun. 30, 2020. The content of all of which is incorporate herein by reference.

### FIELD OF THE DISCLOSURE

The present application relates to the technical field of image processing technologies, in particular to a Micro LED 8K video processing system and method therefor.

### BACKGROUND

Micro-LED is a new generation of display technology (ie, an LED micro-scaling and matrixing technology), that is, an LED (Light Emitting Diode) backlight source is becoming a thin film, being miniaturized and arrayed, which makes an LED unit less than 50 microns. Same as an OLED, the Micro-LED is able to achieve that, each pixel is individually addressed and driven to emit light independently (self-luminescence). Being made of an inorganic material and in a form of self-luminescence, each sub-pixel of red, green and blue generates an own light source before being combined into a pixel. A plurality of key performances of Micro LED, including a resolution, a color gamut, a brightness, a response speed, a service life, an energy consumption, and more, are all superior to those of a mainstream LCD and an emerging OLED. Comparing with existing OLED technology, the Micro-LED has a higher brightness, a better luminous efficiency, and a lower power consumption, as well as a characteristic of self-luminescence without backlight source, a smaller size, lighter and thinner, and becomes an important development direction of an ultra-high definition television display panel.

At present, an ultra-high definition television generally adopts an LCD screen or an OLED screen with a resolution of 3840*2160 (4K), 7680*4320 (8K), as a display screen, and is in corporate with an SOC (System-on-a-Chip) chip to output a complete 4K/8K image to the display screen. Thus, a resolution of an output video signal is limited to very regular resolutions including 4K, 8K and so on. For an Micro LED ultra-high-definition television (5K/6K/7K/8K), due to a characteristic of the Micro LED of being able to be spliced arbitrarily, there is currently no SOC (system on chip) being able to be compatible with 4K/5K/6K/7K/8K screen for a complete video display at the same time. Meanwhile, since an application of an SOC in 8K is just started and a video decoding capability of 8K is under improving, there is no mature SOC that is able to be compatible with a plurality of interfaces including HDMI2.1, DP2.0 and more, while a real 8K decoding capability is not strong.

Therefore, the current technology needs to be improved and developed.

### BRIEF SUMMARY OF THE DISCLOSURE

A main object of the present disclosure is to provide a Micro LED 8K video processing system and method therefor, in order to solve a problem in the prior art that it is impossible to select outputting a video signal for a corresponding area according to a resolution characteristic of a display screen.

In order to achieve the object stated above, the present disclosure provides a Micro LED 8K video processing system, which comprises:

a television signal source, applied to outputting a plurality of video sources with different resolutions;

a video processing board, applied to receiving the video sources output by the television signal source through a plurality of interfaces, identifying a resolution of the video source, performing a stretching processing or a compression processing on the video source according to a resolution to be output, before obtaining a video image, and segmenting the video image into a multi-channel video signal, before sending synchronously the video image to a 4K signal processing board, while sending an audio decoding signal in the video source to a loud-speaker at a same time;

the 4K signal processing board, applied to decoding the video signal being received into an RGB pixel signal, and sending the RGB pixel signal to a Micro LED display screen;

the Micro LED display screen, applied to receiving the RGB pixel signal sent by the 4K signal processing board, so as to light up an entire screen.

In the Micro LED 8K video processing system, further comprises:

a power board, applied to providing a DC power to the video processing board and the 4K signal processing board;

a loud-speaker, applied to outputting a sound after receiving the audio decoding signal from the video processing board;

the television signal source, the video processing board, the 4K signal processing board and the Micro LED display screen are connecting in a sequence, the power board connects to the video processing board and the 4K signal processing board respectively, while the loud-speaker connects to the video processing board.

In the Micro LED 8K video processing system, the video processing board comprises:

a plurality of different kinds of interfaces, applied to receiving the video sources with different resolutions output by the television signal source;

a video segmentation module, applied to segmenting the video image into a multi-channel video signal; and

a synchronization module, applied to encoding the multi-channel video signal into a preset format before sending synchronously to a plurality of the 4K signal processing boards.

In the Micro LED 8K video processing system, the synchronization module is further applied to transmitting the audio decoding signal in the video source obtained after decoding to the loud-speaker.

In the Micro LED 8K video processing system, after having received the video source, the video processing board acquires an external instruction according to an I2C communication interface, and selects receiving the video signal from one interface; after taking the video signal, the video processing board recognizes a resolution of the video source, to identify two resolutions of 4K and 8K, then changes a resolution setting of an FPGA according to the external instruction received by the I2C interface, before selecting to process uniformly the videos with the resolutions of 4K and 8K into a video having a resolution of 4K/5K/6K/7K/8K.

In the Micro LED 8K video processing system, the video segmentation module segments the video image into four parts; and after finishing segmenting, the four parts of the image are output at a same time through a synchronization module, to ensure that each part of the video is consistent, so as to output the image synchronously; and after being processed by the synchronization module, the video signals of the four parts are all encoded into an HDMI 2.0 format or a VBO format, before been output to four 4K signal processing boards at a back end through a 4-way HDMI 2.0 interface or a 4-way 8 lane VBO interface, and after receiving the video signal in an HDMI 2.0 format or a VBO format, each 4K signal processing board decodes the video signal into an image signal in a RGB format, which is further allocated to a 16-path RJ45 interface and output to the Micro LED screen, before the entire screen is finally lit up.

In the Micro LED 8K video processing system, the video processing board comprises three interfaces of HDMI2.1, DP2.0, and 32 lane VBO, while each interface supports an 8K video source input.

In the Micro LED 8K video processing system, the HDMI2.1 interface corresponds to a signal source of HDMI, the DP2.0 interface corresponds to a signal source of DP, and the 32 lane VBO interface corresponds to a signal source of VBO.

In the Micro LED 8K video processing system, the 4K signal processing board receives the video signal through an HDMI2.0 interface, and transmits the RGB pixel signal to the Micro LED display screen through a 16-channel RJ45 interface.

In the Micro LED 8K video processing system, the video processing board is an FPGA, and a model of the FPGA model comprises XCKU115-2FLVA1517I.

In the Micro LED 8K video processing system, the FPGA has eight DDR4 memory chips arranged, each chip has a storage space of 1 GB.

In the Micro LED 8K video processing system, the FPGA performs a plurality of information interactions with an external processing board card through the I2C interface, to obtain a control command and a backhaul status information.

In the Micro LED 8K video processing system, the preset format is an HDMI2.0 format.

In order to achieve the object stated above, the present disclosure provides a Micro LED 8K video processing method, which comprises a plurality of following steps:

the television signal source outputting a plurality of video sources with different resolutions to the video processing board;

the video processing board receiving the video sources output by the television signal source through a plurality of interfaces, identifying a resolution of the video source, performing a stretching processing or a compression processing on the video source according to a resolution required to be output, to obtain a video image, segmenting the video image into a multi-channel video signal, and sending the video image to the 4K signal processing board synchronously, while sending an audio decoding signal in the video source to a loud-speaker;

the 4K signal processing board decoding the video signal received into an RGB pixel signal, and sending the RGB pixel signal to the Micro LED display screen;

the Micro LED display screen receiving the RGB pixel signal sent by the 4K signal processing board to light up the entire screen.

Preferably, in the Micro LED 8K video processing method, the video processing board receiving the video sources output by the television signal source through a plurality of interfaces, identifying a resolution of the video source, performing a stretching processing or a compression processing on the video source according to a resolution required to be output, to obtain a video image, segmenting the video image into a multi-channel video signal, and sending the video image to the 4K signal processing board synchronously, comprises specifically:

when the video processing board recognizes that the resolution of the video source output by the television signal source is a 4K resolution, if a resolution required to be output is the 4K resolution, then the video source is output directly without any processes; If the resolution required to be output is a 5K resolution, a 6K resolution, a 7K resolution, or an 8K resolution, then it is needed to perform a stretching process on the 4K resolution to obtain a video image, and segmenting the video image being stretching processed into a multi-channel video signal before sending to the 4K signal processing board synchronously;

when the resolution of the video source output by the television signal source is a 8K resolution, if a resolution required to be output is the 8K resolution, then the video source is output directly without any processes; If the resolution required to be output is a 4K resolution, a 5K resolution, a 6K resolution, or a 7K resolution, then it is needed to perform a compression process on the 8K resolution to obtain a video image, and segmenting the video image being compression processed into a multi-channel video signal before sending to the 4K signal processing board synchronously.

In the present disclosure, the Micro LED 8K video processing system comprises:

a television signal source, applied to outputting a plurality of video sources with different resolutions; a video processing board, applied to receiving the video sources output by the television signal source through a plurality of interfaces, identifying a resolution of the video source, performing a stretching processing or a compression processing on the video source according to a resolution to be output, before obtaining a video image, and segmenting the video image into a multi-channel video signal, before sending synchronously the video image to a 4K signal processing board, while sending an audio decoding signal in the video source to a loud-speaker at a same time; the 4K signal processing board, applied to decoding the video signal being received into an RGB pixel signal, and sending the RGB pixel signal to a Micro LED display screen; the Micro LED display screen, applied to receiving the RGB pixel signal sent by the 4K signal processing board, so as to light up an entire screen.

By performing a decoding and an image processing to a signal of the image being input, converting a resolution of the image being input to a resolution required according to a user requirement, encoding an image signal being converted, and outputting a multi-channel video signal, selecting and outputting a video signal for a corresponding area according to a resolution characteristic of the display screen, the present disclosure implements a full video signal display.

### BRIEF DESCRIPTION OF THE DRAWINGS

FIG. 1 illustrates a schematic diagram on an embodiment of the Micro LED 8K video processing system in the present disclosure;

FIG. 2 illustrates a schematic diagram on performing a stretching or a compressing process onto the video source according to a resolution required to be output in an embodiment of the Micro LED 8K video processing system in the present disclosure;

FIG. 3 illustrates a schematic diagram on a Micro LED screen with a 4K resolution consisting of 16 small screens in an embodiment of the Micro LED 8K video processing system in the present disclosure;

FIG. 4 illustrates a schematic diagram on an image processing when outputting a 7K video to a 7K screen in an embodiment of the Micro LED 8K video processing system in the present disclosure;

FIG. 5 illustrates a schematic diagram on an image processing when outputting a 6K video to a 6K screen in an embodiment of the Micro LED 8K video processing system in the present disclosure;

FIG. 6 illustrates a schematic diagram on an image processing when outputting a 5K video to a 5K screen in an embodiment of the Micro LED 8K video processing system in the present disclosure;

FIG. 7 illustrates a flowchart on an embodiment of the 8K video processing method for the Micro LED in the present disclosure.

### DETAILED DESCRIPTION OF EMBODIMENTS

In order to make the purpose, technical solution and the advantages of the present disclosure clearer and more explicit, further detailed descriptions of the present disclosure are stated herein, referencing to the attached drawings and some embodiments of the present disclosure. It should be understood that the detailed embodiments of the disclosure described here are used to explain the present disclosure only, instead of limiting the present disclosure.

### Embodiment I

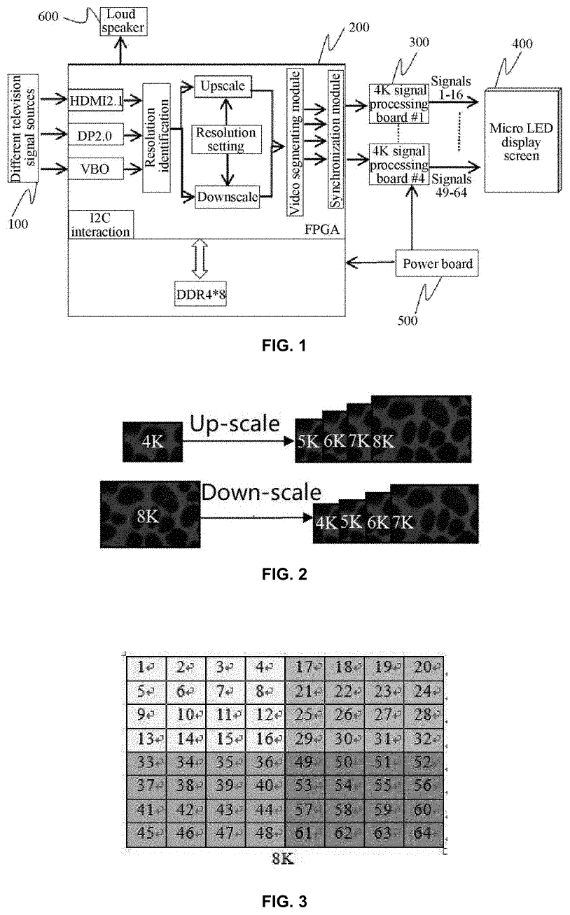

A Micro LED 8K video processing system in a preferred embodiment of the present disclosure, shown as FIG. 1, the Micro LED 8K video processing system comprises:

a television signal source 100, applied to outputting a plurality of video sources with different resolutions; a video processing board 200, applied to receiving the video sources output by the television signal source 100 through a plurality of interfaces, identifying a resolution of the video source, performing a stretching processing or a compression processing on the video source according to a resolution to be output before obtaining a video image, and segmenting the video image into a multi-channel video signal, before sending the video image synchronously to a 4K signal processing board 300, while sending an audio decoding signal in the video source to a loud-speaker 600 at a same time; the 4K signal processing board 300, applied to decoding the video signal being received into an RGB pixel signal, and sending the RGB pixel signal to a Micro LED display screen 400; the Micro LED display screen 400, applied to receiving the RGB pixel signal sent by the 4K signal processing board 300, so as to light up an entire screen.

Further, the Micro LED 8K video processing system comprises: a power board 500, applied to providing a DC power to the video processing board 200 and the 4K signal processing board 300; the television signal source 100, the video processing board 200, the 4K signal processing board 300 and the Micro LED display screen 400 are connecting in a sequence, the power board 500 connects to the video processing board 200 and the 4K signal processing board 300 respectively.

Wherein the video processing board 200 further connects with the loud-speaker 600, the loud-speaker 600 is applied to outputting a sound (that is, sound making) after receiving the audio decoding signal from the video processing board 200; Specifically, the television signal source 100 comprises a plurality of signal sources including HDMI, DP, VBO (32lane the highest), thus the video processing board 200 also comprises a plurality of interfaces, including three types of interfaces of HDMI2.1, DP2.0 and 32lane VBO. And each type of interface supports an input up to an 8K video source (video signal).

Specifically, the video processing board 200 comprises: a plurality of types of interfaces, applied to receiving the video sources with different resolutions output from the television signal source 100 (in an embodiment, the HDMI2.1 interface corresponds to a signal source of HDMI, the DP2.0 interface corresponds to a signal source of DP, and the 32 lane VBO interface corresponds to a signal source of VBO); a video segmentation module, applied to segmenting the video image into a multi-channel video signal (segmenting into 4 channels, in an embodiment); and a synchronization module, applied to encoding the multi-channel video signal (4 channels, in an embodiment) into a preset format before sending synchronously to a plurality of the 4K signal processing boards 300 (4 correspondingly, in an embodiment), while transmitting the audio decoding signal in the video source obtained after decoding to the loud-speaker 600 at a same time.

Further, the video processing board 200 may select an FPGA (Field Programmable Gate Array) equipped with eight DDR4 memory (Double Data Rate SDRAM, the DDR4 memory is a new generation of memory specifications, having a more reliable transmission specification, and a data reliability is further improved; a working voltage is reduced to 1.2V, which is more energy-saving) chips for a development, applied mainly to accomplishing a plurality of functions to the video signal being input, including decoding, video segmentation, resolution scaling, video synchronizing, encoding and outputting, and more; a model of the FPGA can be selected as XCKU115-2FLVD1517I, applied to achieving a plurality of signal processing functions including an image processing and an image segmentation; a cached data in an image processing process stated above is written into or read out from the DDR memory through a DDR controller.

Specifically, the 4K signal processing board 300 receives the video signal (4K image signal, in an embodiment) through an HDMI2.0 interface, and converts the video signal into a RGB pixel signal through a plurality of image processing technologies including decoding, segmentation and more, then transmits the RGB pixel signal to the Micro LED display screen through a 16-channel RJ45 interface (RJ45 is a type of connector for an information socket in a wiring system, the connector comprises a plug and a socket, while the plug has 8 grooves and 8 contacts).

Further, an I2C communication interface is a communication interface between the FPGA and an external processing board, which is able to exchange a plurality of information with the external processing board, to obtain a control command, and return a status information. After receiving the video source, the video processing board 200 obtains an external command according to the I2C communication interface, and selects an interface to receive the video signal. After receiving the video signal, the video processing board 200 identifies a resolution of the video source and identifies two resolutions of 4K and 8K, followed by changing a resolution setting of the FPGA according to the external command received by the I2C interface and choosing to process the video with a 4K resolution and an 8K resolution uniformly into a video with a 4K/5K/6K/7K/8K resolution.

Shown as FIG. 2, if a 4K video is input and a 4K is output, then no processing is required. If a 5K, 6K, 7K or 8K resolution is output, then a stretching process will be required (that is, Upscale in the FIG. 1 or Up-scale in the FIG. 2) to stretch the image into a larger resolution. If a 8K video is input and a 8K is output, then no processing is required. If a 4K, 5K, 6K or 7K resolution is output, then a compression process will be required (that is, Downscale in FIG. 1, or Down-scale in FIG. 2) to compress the image into a smaller resolution, then a video with a resolution that meets a setting requirement will be obtained. Followed by the video segmentation module segments the video image into four parts; and after finishing segmenting, the four parts of the image are output at a same time through a synchronization module, to ensure that each part of the video is consistent, so as to make the image be output synchronously; and after being processed by the synchronization module, the video signals of the four parts are all encoded into an HDMI 2.0 format, before been output to four 4K signal processing boards at a back end through a 4-way HDMI 2.0 interface, and after receiving the video signal in an HDMI 2.0 format, each 4K signal processing board decodes the video signal into an image signal in a RGB format (that is, a RGB pixel signal), which is further allocated to a 16-path RJ45 interface and output to the Micro LED screen, before the entire screen is finally lit up.

Further, after performing a video stretching and compression in the video processing board 200, and converting the video format into a resolution suitable for the Micro LED display screen through stretching or compressing, before being divided into 4 channels of 4K resolution image for output. Shown as FIG. 3, since the 4K video signal being output to the 4K signal processing board 300 will be segmented into a video with a 16-channel RGB signals again, thus it can be considered that a 4K resolution Micro LED screen is composed by 16 small screens, a resolution of each small screen is 960*540, then a 4K screen will be spliced according to a 4*4 splicing method (shown as FIG. 3).

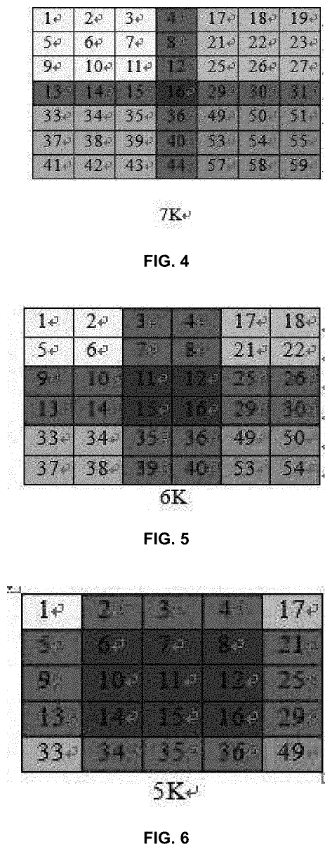

At this time, if an 8K video is output onto an 8K screen, the four HDMI2.0 channels of the video processing board 200 will light up a 4K screen respectively, before being finally spliced into a complete picture; if a 7K video is output on a 7K screen (shown as FIG. 4), then the video processing board 200 also segments the video into 4 pictures of 4K for output when performing an image processing, while each picture is overlapped, shown as FIG. 4, a middle part (excluding a small block in a most middle, that is, the small block represented by 16) is an overlapping part that shall appear in two 4K pictures, and the small block in the most middle (that is, the small block represented by 16) is an overlapping part of all 4 pictures in 4K. After such a process, each 4K picture is relatively complete, and an FPGA algorithm is unified, which is able to save an FPGA computing resource. At a same time, after being transmitted to the 4K signal processing board 300, since the 4K signal processing board can segment an image into 16 parts again, at this time, for the overlapping parts, wherein one channel can be transmitted to the back-end of the Micro LED display screen, without transmitting a plurality of rest parts, so that a same set of 8K video processing solution for the Micro LED can be compatible with a 7K resolution video output. Similarly, shown as FIG. 5 and FIG. 6, a video of 6K or 5K resolution can be output to adapt to the back-end of the Micro LED display screen according to this rule. When outputting to a Micro LED-4K screen, 4 channels of HDMI2.0 can output a same 4K picture, then the video processing board 200 can be used as a 4-channel 4K player.

### Embodiment II

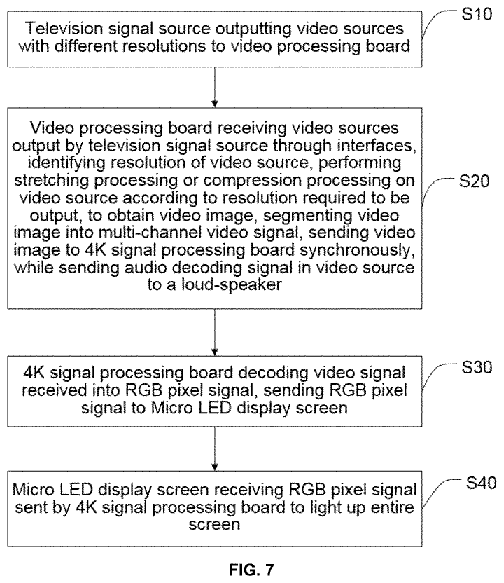

An 8K video processing method for the Micro LED as stated in a preferred embodiment in the present disclosure, as shown in FIG. 7, the 8K video processing method for the Micro LED comprises a plurality of following steps:

Step S10, the television signal source outputting a plurality of video sources with different resolutions to the video processing board;

Step S20, the video processing board receiving the video sources output by the television signal source through a plurality of interfaces, identifying a resolution of the video source, performing a stretching processing or a compression processing on the video source according to a resolution required to be output, to obtain a video image, segmenting the video image into a multi-channel video signal, and sending the video image to the 4K signal processing board synchronously, while sending an audio decoding signal in the video source to a loud-speaker;

Step S30, the 4K signal processing board decoding the video signal received into an RGB pixel signal, and sending the RGB pixel signal to the Micro LED display screen;

Step S40, the Micro LED display screen receiving the RGB pixel signal sent by the 4K signal processing board to light up the entire screen.

Wherein when the video processing board recognizes that the resolution of the video source output by the television signal source is a 4K resolution, if a resolution required to be output is the 4K resolution, then the video source is output directly without any processes; If the resolution required to be output is a 5K resolution, a 6K resolution, a 7K resolution, or an 8K resolution, then it is needed to perform a stretching process on the 4K resolution to obtain a video image, and segmenting the video image being stretching processed into a multi-channel video signal before sending to the 4K signal processing board synchronously.

Wherein when the video processing board recognizes that the resolution of the video source output by the television signal source is a 4K resolution, if a resolution required to be output is the 4K resolution, then the video source is output directly without any processes; If the resolution required to be output is a 5K resolution, a 6K resolution, a 7K resolution, or an 8K resolution, then it is needed to perform a stretching process on the 4K resolution to obtain a video image, and segmenting the video image being stretching processed into a multi-channel video signal before sending to the 4K signal processing board synchronously.

The present disclosure proposes a brand new 8K video processing technical solution for an 8K ultra-high-definition image of the Micro LED, the video processing board in the present disclosure adopts an HDMI2.1 interface, a DP2.0 interface, or a 32laneVBO interface, to support up to 8K signal input, having rich 8K video input interfaces and a powerful true 8K decoding processing capability; the image signal being input is decoded and image processed inside a chip processor, and a resolution of the image being input can be converted to any one of 4K/5K/6K/7K/8K, together with encoding the image signal having been converted, and outputting 4 channels of the video signal in 4K with a HDMI2.0 or VBO format to the 4K signal processing board at the back-end. The 4K signal processing board selects and outputs a video signal of a corresponding area, according to a resolution characteristic of the display screen, to achieve a complete video signal display.

The present disclosure, according to a feature of a Micro LED display screen being able to be spliced arbitrarily, is able to adjust flexibly according to a resolution of the back-end of the Micro LED display screen, and perform a corresponding scaling processing on the resolution of the image being input, to be compatible with a video output having a 4K/5K/6K/7K/8K resolution, having a strong compatibility, being able to be applied not only in a plurality of aspects including the video segmentation and splicing for an ultra-high-definition TV on the Micro LED, but also being applicable for a plurality of other splicing screens, large display screens of LCD, OLED and more, having a flexible and broad applicability.

All above, the present disclosure provides an 8K video processing system and method for the Micro LED, the system comprises: a television signal source, applied to outputting a plurality of video sources with different resolutions; a video processing board, applied to receiving the video sources output by the television signal source through a plurality of interfaces, identifying a resolution of the video source, performing a stretching processing or a compression processing on the video source according to a resolution to be output, before obtaining a video image, and segmenting the video image into a multi-channel video signal, before sending synchronously the video image to a 4K signal processing board, while sending an audio decoding signal in the video source to a loud-speaker at a same time; the 4K signal processing board, applied to decoding the video signal being received into an RGB pixel signal, and sending the RGB pixel signal to a Micro LED display screen; the Micro LED display screen, applied to receiving the RGB pixel signal sent by the 4K signal processing board, so as to light up an entire screen. The present disclosure, by performing a decoding and an image processing to a signal of the image being input, converting a resolution of the image being input to a resolution required according to a user requirement, encoding an image signal being converted, and outputting a multi-channel video signal, selects and output a video signal for a corresponding area according to a resolution characteristic of the display screen, to implement a full video signal display.

It should be understood that, the application of the present disclosure is not limited to the above examples listed. Ordinary technical personnel in this field can improve or change the applications according to the above descriptions, all of these improvements and transforms should belong to the scope of protection in the appended claims of the present disclosure.

1. A Micro LED 8K video processing system comprising:
a television signal source configured to output a plurality of video sources with different resolutions;
a video processing board configured to receive the video sources output by the television signal source through a plurality of interfaces, identify a resolution of the video source, perform a stretching processing or a compression processing on the video source according to a resolution to be output, to obtain a video image, and segment the video image into a multi-channel video signal to be sent synchronously the video image to a 4K signal processing board, while sending an audio decoding signal in the video source to a loud-speaker at a same time;
wherein the 4K signal processing board is configured to decode the video signal being received into an RGB pixel signal, and send the RGB pixel signal to a Micro LED display screen; and
wherein the Micro LED display screen is configured to receive the RGB pixel signal sent by the 4K signal processing board to light up an entire screen.

2. The Micro LED 8K video processing system according to claim 1 comprising:
a power board configured to provide a DC power to the video processing board and the 4K signal processing board;
a loud-speaker configured to output a sound after receiving the audio decoding signal from the video processing board; and
wherein the television signal source, the video processing board, the 4K signal processing board, and the Micro LED display screen are connected in a sequence, whereby the power board connects to the video processing board and the 4K signal processing board respectively, while the loud-speaker connects to the video processing board.

3. The Micro LED 8K video processing system according to claim 1, wherein the video processing board comprises:
a plurality of different kinds of interfaces configured to receive the video sources with different resolutions output by the television signal source;
a video segmentation module configured to segment the video image into a multi-channel video signal; and
a synchronization module configured to encode the multi-channel video signal into a preset format to be sent synchronously to a plurality of the 4K signal processing boards.

4. The Micro LED 8K video processing system according to claim 3, wherein the synchronization module is further configured to transmit the audio decoding signal in the video source obtained by decoding to the loud-speaker.

5. The Micro LED 8K video processing system according to claim 3, wherein after having received the video source, the video processing board acquires an external instruction according to an I2C communication interface, and selects receiving the video signal from one interface; and
wherein after taking the video signal, the video processing board recognizes a resolution of the video source to identify two resolutions of 4K and 8K, then changes a resolution setting of an FPGA according to the external instruction received by the I2C interface to process uniformly the videos with the resolutions of 4K and 8K into a video having a resolution of at least one of: 4K, 5K, 6K, 7K, or 8K.

6. The Micro LED 8K video processing system according to claim 5, wherein the video segmentation module segments the video image into four parts;
after finishing segmenting, the four parts of the image are output at a same time through a synchronization module to ensure that each part of the video is consistent, so as to output the image synchronously;
after being processed by the synchronization module, the video signals of the four parts are all encoded into an HDMI 2.0 format or a VBO format to be output to four 4K signal processing boards at a back end through a 4-way HDMI 2.0 interface or a 4-way 8 lane VBO interface; and
after receiving the video signal in the HDMI 2.0 format or the VBO format, each 4K signal processing board decodes the video signal into an image signal in a RGB format, which is further allocated to a 16-path RJ45 interface and output to the Micro LED screen, to finally light up the entire screen.

7. The Micro LED 8K video processing system according to claim 3, wherein the video processing board comprises three interfaces of HDMI2.1, DP2.0, and 32 lane VBO, while each interface supports an 8K video source input.

8. The Micro LED 8K video processing system according to claim 7, wherein the HDMI2.1 interface corresponds to a signal source of HDMI, the DP2.0 interface corresponds to a signal source of DP, and the 32 lane VBO interface corresponds to a signal source of VBO.

9. The Micro LED 8K video processing system according to claim 1, wherein the 4K signal processing board receives the video signal through an HDMI2.0 interface and transmits the RGB pixel signal to the Micro LED display screen through a 16-way RJ45 interface.

10. The Micro LED 8K video processing system according to claim 1, wherein the video processing board is an FPGA, and a model of the FPGA model is XCKU115-2FLVA1517I.

11. The Micro LED 8K video processing system according to claim 10, wherein the FPGA has eight DDR4 memory chips arranged, wherein each chip has a storage space of 1 GB.

12. The Micro LED 8K video processing system according to claim 10, wherein the FPGA performs a plurality of information interactions with an external processing board card through the I2C interface to obtain a control command and a backhaul status information.

13. The Micro LED 8K video processing system according to claim 3, wherein the preset format is an HDMI2.0 format.

14. A Micro LED 8K video processing method for the Micro LED 8K video processing system according to of claim 1, the Micro LED 8K video processing method comprising:
outputting, from the television signal source, a plurality of video sources with different resolutions to the video processing board;
receiving, by the video processing board, the video sources output by the television signal source through a plurality of interfaces, identifying a resolution of the video source, performing a stretching processing or a compression processing on the video source according to a resolution required to be output to obtain a video image, segmenting the video image into a multi-channel video signal, and sending the video image to the 4K signal processing board synchronously, while sending an audio decoding signal in the video source to a loud-speaker;
decoding, by the 4K signal processing board, the video signal received into an RGB pixel signal, and sending the RGB pixel signal to the Micro LED display screen; and
receiving, by the Micro LED display screen, the RGB pixel signal sent by the 4K signal processing board to light up the entire screen.

15. The Micro LED 8K video processing method according to claim 14, wherein receiving, by the video processing board, the video sources output by the television signal source through a plurality of interfaces, identifying a resolution of the video source, performing a stretching processing or a compression processing on the video source according to a resolution required to be output to obtain a video image, segmenting the video image into a multi-channel video signal, and sending the video image to the 4K signal processing board synchronously, comprises:
when the video processing board recognizes that the resolution of the video source output by the television signal source is a 4K resolution, if a resolution required to be output is the 4K resolution, then the video source is output directly without any processes; if the resolution required to be output is a 5K resolution, a 6K resolution, a 7K resolution, or an 8K resolution, then performing a stretching process on the 4K resolution to obtain a video image, and segmenting the video image being stretching processed into a multi-channel video signal before sending to the 4K signal processing board synchronously; and
when the resolution of the video source output by the television signal source is a 8K resolution, if a resolution required to be output is the 8K resolution, then the video source is output directly without any processes; if the resolution required to be output is a 4K resolution, a 5K resolution, a 6K resolution, or a 7K resolution, then performing a compression process on the 8K resolution to obtain a video image, and segmenting the video image being compression processed into a multi-channel video signal before sending to the 4K signal processing board synchronously.
